(19) United States
(12) Patent Application Publication
(10) Pub. No.: US 2014/0225885 A1
(43) Pub. Date: Aug. 14, 2014

(54) SYSTEM AND METHOD FOR VIEWING MULTIPLEXED IMAGES

(71) Applicant: Babak Sheikh, Weston, FL (US)

(72) Inventor: Babak Sheikh, Weston, FL (US)

(21) Appl. No.: 13/763,687

(22) Filed: Feb. 10, 2013

(51) Int. Cl. G06T 15/00

(52) U.S. Cl. CPC G06T 15/005
USPC 345/419

(57) ABSTRACT

A system for displaying and viewing multiple two- or three-dimensional images from a single screen includes an image source displaying the images as time-multiplexed, shutter glasses for viewing the images, and a hand-held selection devices for choosing an image to view. Each image may be one of a series of images, and the images may be accompanied by sound that is played through earphones, with the sound programa being selected along with the image. In one version, certain images are always available for selection, while other images must be selected to be placed in an available time slot.

### RELATED APPLICATIONS

Not Applicable

### FEDERALLY SPONSORED RESEARCH OR DEVELOPMENT

Not Applicable

### BACKGROUND OF THE INVENTION

1. Field of the Invention

This invention relates to

2. Summary of the Background Art

It is well known that a three-dimensional (3D) image of a scene is viewed by an individual when his eyes are presented with separate images of the scene, formed at positions latterly separated by a distance similar to the distance between the eyes of a human being. Such images differ in parallax conditions, with near objects therein being laterally displaced while distant objects are shown in the same places. Such separate images may be formed from photographs taken by laterally separated camera lenses, and can alternately be generated as images, such as cartoons, drawn by hand, or by a computer graphics program.

A need for separate images for the right and left eyes of one or more individuals to allow a presentation to be viewed in three dimensions has resulted in the development of methods to separate composite images, dividing images for the right eye and for the left eye into component parts, with such a method being used both with a stationary image and with a series of images, or frames, forming a moving image.

A schematic view of one such method is shown in shown as a block diagram in FIG. 1, with an image source 10 providing a composite image 12 having component images that are orthogonally polarized from one another to a right polarizing filter 14 and a left polarizing filter 16. For example, the composite image 12 is formed by separately polarizing images for the left and right eye, with the images being reflected from a single viewing screen. The right polarizing filter 14 transmits light polarized in a first direction in the form of a first component image 18 to the right eye 20, while the left polarizing filter 16 transmits light polarized in a second direction, perpendicular to the first direction, in the firm of a second component image 22, to the left eye 24. FIG. 2 shows is + vertical cross-sectional elevation of a pair of 3D glasses 26 including the right polarizing filter 14, which is held in front of the right eye 20 of the viewer by a frame 28, with the elevation being taken through the right polarizing filter 14. The left polarizing filter 16 is similarly held in front of the left eye 24.

A schematic view of a second method for separating images for the right and left eyes is shown in the block diagram of FIG. 3. An image source 40 provides an unpolarized composite image 42 in which the component images for the right and left eyes are time multiplexed, i.e., in which the component images are alternately presented in a series of pulses, along with a synch signal 44 that indicates when these pulses occur. For example, the synch signal 44 is turned on when an image for the right eye is presented and off when an image for the left eye is presented. Both the unpolarized component image 42 and the synch signal 44 are provided as inputs to a pair of shutter glasses 46, which include a right shutter 48, held in front of the right eye 50, and a left shutter 52, held in front of the left eye 54.

Each of the shutters 48, 52 includes a first polarizing filter 56, which produces a first intermediate image 58 polarized in a first direction, a second polarizing filter 60, which blocks light polarized in the first direction while passing while passing light passed in a second direction, perpendicular to the first direction, and a switchable optical rotator 62. The optical rotator 62, which typically includes a twisted nematic liquid crystal device (LCD), is electrically switchable between a closed position, in which polarized light is passed without changing its angle of polarization, and an open position, in which the angle of polarization of light is rotated through a 90-degree angle as the light is passed through the rotator 62. In the example of the figure, within the right shutter 48, the polarity of the first intermediate image 58 is rotated 90-degrees while passing through the switchable optical rotator 62 in the open position, to form a second intermediate image 64, which passes through the second polarizing filter 60 to form an output image 66 entering the right eye 50. Simultaneously, within the left shutter 52, the polarity of the first intermediate image 58 is not rotated while passing through the switchable optical rotator 62, so that the second intermediate image 64 remains polarized in the first direction, causing the second polarizing filter 60 blocks transmission of light into the left eye 54. As the images intended for the right and left eyes are transmitted from the image source 40, the synch signal 44 is used to synchronize the shutter glasses 46 with the image source 40, so that the switchable optical rotators 62 are opened and closed at the times needed to transmit the appropriate image.

FIG. 4 is a vertical cross-sectional elevation of the pair of shutter glasses 46, taken through the right shutter 48, which is held in front of the right eye 50 by a frame 68. The right shutter 48 includes the first polarizing filter 56 and the second polarizing filter 60 on opposite sides of the switchable optical rotator 62. The left shutter 52 is similarly held in front of the left eye 54.

Recently, multi-viewer applications have been developed, with multiplexed images allowing two or more viewers to see different scenes, or the same scene from different points of view, on the same display screen. For example, a video game configured for use by two players may show each player a view of a playing field from his own point of view. Other applications allow individuals to choose among multiple movies or segments of movies projected as components of a composite image. A technology using shutter glasses is presently available to allow a viewer of a composite image stream to view one of three different three-dimensional image streams or one of six different two-dimensional image streams, These limitations are based on the switching capabilities of shutter glasses, on a need to provide separate images for the right and left eyes to form three-dimensional images, and on a need to avoid seeing ghost images from another image stream. The patent literature includes a number of descriptions of methods for allowing the composite display and viewing of greater numbers of images, including methods using both shutter glasses and separately polarized images.

### SUMMARY OF THE INVENTION

In accordance with a first aspect of the invention, apparatus is provided for displaying and viewing multiple images on a single screen, with the apparatus comprising an image source, a plurality of hand-held selection devices, and a plurality of shutter glasses. The image source displays multiple images on a single screen, separated by time multiplexing, and broadcasts a synch signal, indicating when the images are changed for one another and a data signal describing content of the multiple images and describing a pattern in which the individual images are displayed. The plurality of hand-held selection devices, receiving the data signal from the image source and displaying a menu screen showing available image selections, and accepting a user selection of an available image, and each associated with one of the shutter glasses to transmit a shutter initialization signal to the shutter glasses, causing the shutter glasses to then open as needed to view the selected image At least some of the images are displayed over time as part of a series of images forming a moving picture. The plurality of shutter glasses are each arranged to fit over a nose and ears of a wearer while holding a right shutter therein in line with the right eye of the user and a left shutter therein in line with the left eye of the user.

In accordance with a first embodiment of the invention, each of the shutter glasses begins to transmit the selected image after receiving the shutter initialization signal from the selection device associated with the shutter glasses, to continue transmitting only the selected image as long as it is available unless required to do otherwise by a user action. In this way, since none of the selection devices and none of the shutter glasses transmit radio messages, a large number of individuals, each using a selection device and shutter glasses can occupy a room, such as a theater, without causing interference between radio signal. For example, an image is considered to be available to shutter glasses if the synch signal from the image supplier can be detected by the shutter glasses. In one version of the invention, when an image that has become unavailable is determined to have become available again, the shutter glasses are arranged to view the image again. This capability allows a person to leave a place at which material is being presented, to go to another place, and to the resume watching the same type of program without having to make a new selection.

The image source may display a first plurality of two-dimensional images, each time-multiplexed to be each held within a single time slot, together with a second plurality of three-dimensional images, each including a right image intended for the right eye and a left image, intended for the left eye, wherein the left and right images are in different slots as time multiplexed The image source may additionally broadcasts a plurality of sound tracks, each associated with one or more images in the first plurality of images, with the apparatus additionally including at least one earphone associated with each selection device the hand-held selection devices causes the at least one earphone to be tuned to a radio channel from the image source through which audio associated with the selected images is being played. the selection device may comprise a cell phone executing an app for controlling the viewing of images in communication with the shutter glasses and with the image source.

In accordance with a second embodiment of the invention, the image source provides a first plurality of images that are all being displayed for immediate selection and at least one on-demand slot among the time slots formed by time-multiplexing to be filled by an image selected using one of the selection devices from a second plurality of images not being displayed. Preferably, while as one of the control devices receives an indication that a user wants to continue viewing an image from an on-demand slot, a program executing within the causes a continuation request to be transmitted from the control device, so that the image supplier will retain the image in the on-demand slot in response to a determination that the image is still available, and instead causes the selection device to generate a demand request to place the image in an “on-demand” slot in response to a determination that the image is no longer available. For example, the first plurality of the images includes signs in languages that are commonly used locally, while the second plurality of the images includes signs in languages that are not commonly used locally. Images within the first plurality are held in locations within the time-multiplexing structure form which they can always be selected for display using any of the selection devices, while images within the second plurality are held in the on-demand slots within the multiplexing. The apparatus may additionally show a plurality of three-dimensional movies arranged for selection using the selection device with viewing using the shutter glasses.

In accordance with a third embodiment of the invention, the image source displays a plurality of three-dimensional images, each including a right image intended for the right eye and a left image, intended for the left eye, with the images being arranged together to provide a viewer with a sense of a three-dimensional image, with the image source polarizing the right image in a first direction and polarizing the left image in a second direction, orthogonal to the first direction. Then, the right shutter is additionally arranged to transmit only light polarized in the first direction to the right eye of the viewer, and the left shutter is additionally arranged to transmit only light polarized in the second direction to the left eye of the viewer. the right shutter of the shutter glasses comprises a first right polarizing filter passing light polarized in the first direction and blocking light polarized in the second direction, a right switchable rotator that rotates a direction of polarization of light from the first right polarizing filter through a 90-degree angle with the rights switchable rotator switched on and passing light from the first right polarizing filter without rotation with the right switchable rotator switched off, and a second right polarizing filter blocking light from the right switchable rotator polarized in the first direction and passing light from the right switchable rotator polarized in the second direction. The left shutter of the shutter glasses comprises a left right polarizing filter passing light polarized in the second direction and blocking light polarized in the first direction, a left switchable rotator that rotates a direction of polarization of light from the first left polarizing filter through a 90-degree angle with the left switchable rotator switched on and passing light from the first left polarizing filter without rotation with the right switchable rotator switched off, and a second left polarizing filter blocking light from the right switchable rotator polarized in the second direction and passing light from the right switchable rotator polarized in the first direction. Preferably, the left and right images forming a single three-dimensional image are in a single time slot as multiplexed.

In accordance with a fourth embodiment of the invention, the system comprises a plurality of image sources, each of which displays multiple images on a single screen, separated by time multiplexing, and broadcasting a synch signal, indicating when the images are changed for one another and a data signal describing content of the multiple images and a pattern in which the individual images are displayed. Additionally, each of the selection devices receiving a data signal displays a menu derived from information received within the data signal accepts a user selection of an item from the men, and transmits a shutter initialization signal, starting the shutter glasses associated with the selection device operating to transmit the images associated with the menu item. After losing contact with the data signal, upon regaining contact with the data signal the selection device establishes that the data signal indicates that a previously selected image is still available and transmits a shutter initialization signal causing the shutter glasses to transmit the previously selected image.

For example, one of the image sources provides a first plurality of images that are all being displayed for immediate selection and wherein another of the image sources provides at least one on-demand slot among the time slots formed by time-multiplexing to be filled by an image selected using one of the selection devices from a second plurality of images not being displayed. As one of the control devices receives an indication that a user wants to continue viewing an image from an on-demand slot a program executing within the causes a continuation request to be transmitted from the control device, so that the image supplier will retain the image in the on-demand slot, in response to a determination that the image is still available, and instead causes the selection device to generate a demand request to place the image in an on-demand slot in response to a determination that the image is no longer available. Images within the first plurality may be held in locations within the time-multiplexing structure form which they can always be selected for display using any of the selection devices, while images within the second plurality are held in the on-demand slots within the time multiplexing, with the second plurality of images including signs in languages that are not commonly used locally. One of the image sources may comprise a theater displaying a plurality of three-dimensional movies including sound, while another of the image sources comprises a sign. The sign may include a plurality of images of directions for reaching different destinations, while the images within the sign are each selected according to a direction, or the sign may include a plurality of messages targeted for different demographic groups, with the images within the sign being selected according to a demographic group.

### BRIEF DESCRIPTION OF THE DRAWINGS

FIG. 1 is a block diagram showing a schematic view of a first prior art method for separating component images;

FIG. 2 is a vertical cross-sectional view of a pair of 3D glasses used in the method of FIG. 1;

FIG. 3 is a block diagram showing a schematic view of a second prior art method for separating component images;

FIG. 4 is a vertical cross-sectional view of a pair of shutter glasses used in the method of FIG. 3;

FIG. 5 is a block diagram showing a schematic view of a system for viewing multiplexed images, configured according to the invention.

FIG. 6 is a front elevation of a first version of a selection device within the system of FIG. 5;

FIG. 7 is a front elevation of a second version of a selection device within the system of FIG. 5.

FIG. 8 is a block diagram showing a schematic view of an image source within the system of FIG. 5;

FIG. 9 is a block diagram showing a schematic view of the selection device within the system of FIG. 5;

FIG. 10 is a graphical view of time slots allocated for viewing multiple three-dimensional images from an image source within the system of FIG. 5, arranged in accordance with a first embodiment of the invention;

FIG. 11 is a tabular view of a data structure stored within the image source of FIG. 8, in accordance with the first embodiment of the invention;

FIG. 12 is a flow chart showing a process occurring within the selection device of FIG. 9 in accordance with the first embodiment of the invention;

FIG. 13 is a graphical view of time slots allocated for viewing multiple three-dimensional images from the image source of FIG. 8, arranged in accordance with a second embodiment of the invention;

FIG. 14 is a tabular view of a data structure stored within the image source of FIG. 8, in accordance with the second embodiment of the invention;

FIG. 15 is a display screen view of a menu displayed on a the selection device of

FIG. 16 is a schematic view of data and instruction storage within the image source of FIG. 8, configured according to the second embodiment of the invention;

FIG. 17 is a flow chart showing a process occurring within the image source of FIG. 8 in accordance with the second embodiment of the invention;

FIG. 18 is a flow chart showing a process occurring within the selection device of FIG. 9 in accordance with the second embodiment of the invention;

FIG. 19 is a block diagram of a schematic view of a system for viewing multiplexed images, configured in accordance with a third embodiment of the invention, with shutters open within shutter glasses therein;

FIG. 20 is a block diagram of the system of FIG. 19, with shutters closed within shutter glasses therein;

FIG. 21 is a block diagram of an image source within the system of FIG. 19;

FIG. 22 is a tabular view of a data structure stored within the image source of FIG. 19;

FIG. 23 is a schematic view of a first system for viewing multiplexed images in accordance with a fourth embodiment of the invention;

FIG. 24 is a perspective view of a kit within the system of FIG. 23; and

FIG. 25 is a schematic view of a second system for viewing multiplexed images in accordance with a fourth embodiment of the invention.

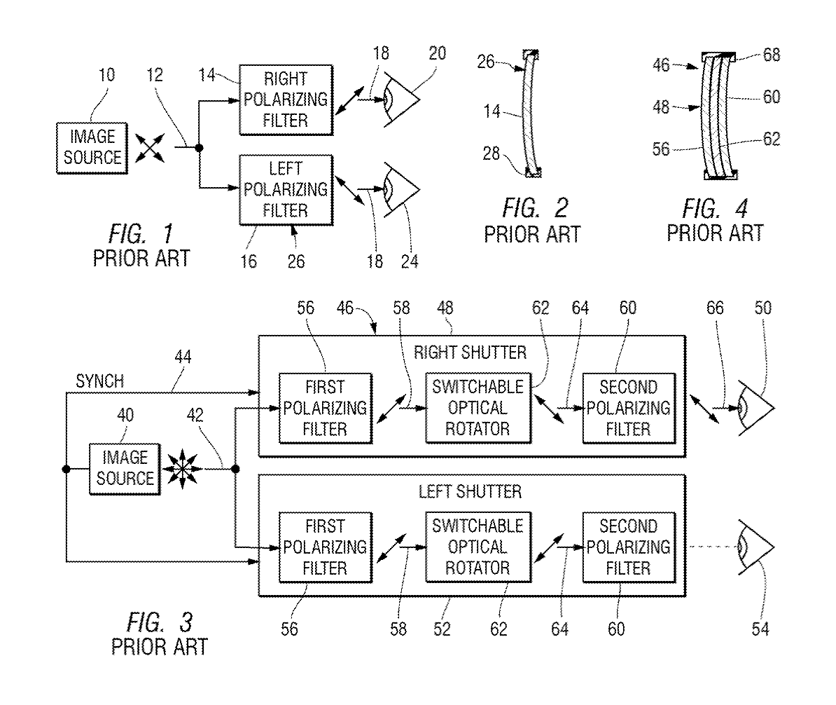

### DETAILED DESCRIPTION OF THE INVENTION

FIG. 5 is a block diagram showing a schematic view of a system 100 for viewing multiplexed images, configured according to the invention. The system 100 includes an image source 102, which provides a number of time-multiplexed images 103, intended for two- or three-dimensional viewing through shutter glasses 104. These images may be non-polarized, with all of the image separation of images being performed by the operation of shutters, or they may be orthogonally polarized, with a portion of the separation of images being performed by polarizing filters provided within the shutter glasses 104. For, example, a method for separating polarized images within shutter glasses may be used, as described in U.S. Pat. No. 8,179,427 B2, the disclosure of which is incorporated herein by reference. As a pair of the shutter glasses 104 is moved close enough to the image source to allow the viewing of images therefrom, the shutter glasses 104 begin receiving a synch signal 106 emanating from the image source 102 as a radio signal. The synch signal 106, which is synchronized with the presentation of time-multiplexed signals 103, is used within the shutter glasses 104 to ensure that only the selected images are allowed to pass through the shutter glasses 104. Preferably, the shutter glasses include a left shutter that is held in front of the left eye and a right shutter that is held in front of the right eye, with the shutters being capable of separate or simultaneous operation. The system 100 may additionally include one or more additional image sources 108, with the image sources 102, 108 preferably being separated, by distance and/or by intervening structures, sufficiently that the radio signals transmitted from or to the different image sources 102, 108 do not interfere with one another so that each pair of shutter glasses 104 and each selection device 112 receives radio signals from, and sends radio signals to, only the closest image source 102, 108.

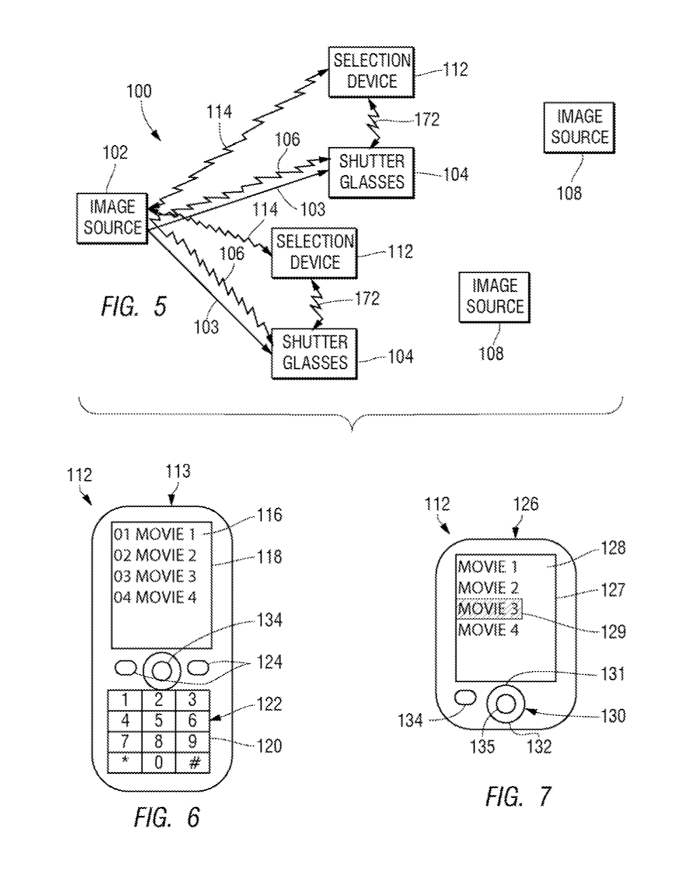

FIG. 6 is a front elevation of a first version 113 of the selection device 112, which is used with each pair of shutter glasses 104 for selecting the particular image or series of images to be viewed. In one version of the invention, the selection device 112 receives a data signal 114 from the image source 102, as an individual holding the selection device 112 moves close enough to view images from the image source. The selection device 112 then displays menu items 116 derived from the data signal 114 on a display screen 118. The viewer then indicates a choice of one of the items within the menu 116 by depressing one or more buttons 120 in the keyboard 122 of the selection device 112. If the entire menu 116 cannot be displayed on the display screen 118, scroll buttons 124 may be used to move the menu 116 along the display screen 118 so that different portions of the menu 116 can be viewed.

FIG. 7 is a front elevation of a second version 126 of the selection device 112, which may be used with each pair of shutter glasses 104 within the system 100 in place of the previously-described selection device 112. The alternate selection device 126 includes a display screen 127 upon which menu items 128 are displayed with one of the menu items 128 being shown within a highlighted area 129 having, for example, a different background color. The alternate selection device 126 includes an annular control button 130, having an upper portion 131, which is depressed to move the highlighted area 129 upward, and a lower portion 132, which is depressed to move the highlighted are 129 downward. The alternative selection device 126 further includes a central selection button 133, which is depressed to select the menu item 128 being displayed within the highlighted area 129. Alternately or additionally, the display screen 127 may be provided with a touch-sensitive capability allowing the selection of a menu item 128 by touching the display screen 127 where the menu item 128 is displayed. If all the menu items 128 cannot all be displayed on the display screen 127, the display of the menu items 128 is moved with the highlighted area 129 as required so that the highlighted menu item 128 is always shown.

In this way, either version 113, 126 of the selection device 112 is used to select images 103 from the image source 102, with the available choices being determined from the data signal 114 transmitted from the image source 102. Following the selection, the selection device 112 sends a shutter initialization signal 133 to the shutter glasses 104 to establish a pattern for operation of the left and right shutters therein according to the synch pulses 106 from the image source 102 to receive the selected images. Preferably, to conserve battery power within the selection device 112, the display screen 118, 127 is turned off except when a selection is to be made. For this purpose, either version 113, 126 additionally includes a “view menu” button 134, which is depressed to turn on the screen when it is desired to do so.

The selection device 112 may be a special-purpose, hand-held electronic device particularly built to operate as described herein. Alternately, the selection device 112 may be a cellular device, often called a “smartphone” running an app that has been downloaded to provide the process steps and communication facilities described herein. For example, the ability of the cellular device to connect to a digital cellular network may be used to download the app from an app supplier, while the ability of the cellular device to communicate with a local access point is used to communicate with the image source 102, and while the ability of the cellular device to communicate with other local devices, as through Bluetooth, is used to communicate with the shutter glasses 104.

FIG. 8 is a block diagram showing a schematic view of the image source 102 within the system 100 of FIG. 5. The image source 102 includes a microprocessor 140 with data and instruction storage 141. The microprocessor 140 executes instructions within an operating system 142 stored in data and instruction storage 141 to control a transceiver 144 and a display device 146 through adapter circuits 148. The display device 146, which may be an LCD (liquid crystal display), displays time-multiplexed images 150. The transceiver 144, which may comprise several separate devices, receives data from an external controller or network (not shown) when it is necessary to vary operation of the image source 102, and transmits both the data signal 114 and synch pulses 106. In some embodiments of the invention, the transceiver 144 additionally receives requests from selection devices 112 close enough to establish local communications. The microprocessor determines the content of the data signal 114 from a data structure stored within a register 152, preferably the data signal 114 comprising a data structure derived from data stored within the register transmitted periodically.

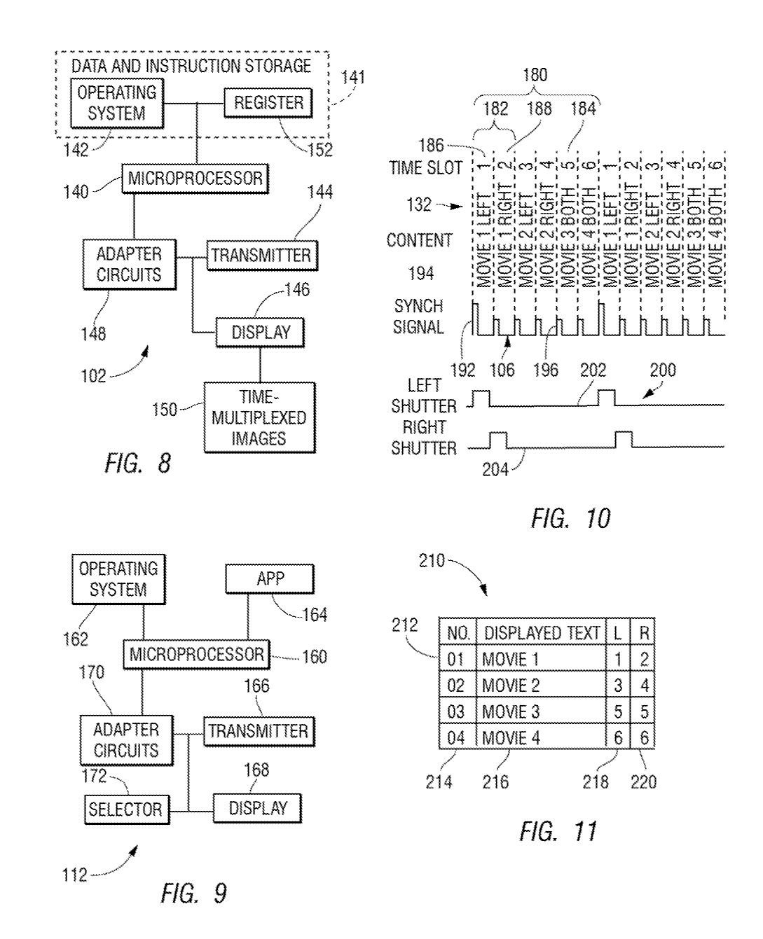

FIG. 9 is a block diagram providing a schematic view of a selection device 112 within the system 100 of FIG. 5. The selection device 112 includes a microprocessor 160, executing instructions within a stored operating system 162 and within a stored app 164, which includes instructions specific to operation as described herein. The microprocessor 160 controls a transceiver 166, which may comprise separate devices, and a display 168, through adapter circuits 170. The display 168 is, for example, either the display 118 of FIG. 6 or the display 127 of FIG. 7. The microprocessor 160 additionally receives inputs from a selector 171, which comprises the keyboard 122 of FIG. 6, the knob 130 of FIG. 7, or a touch-sensitive display, as further described above in reference to FIG. 7.

Operation of the system 100 for viewing multiplexed images in accordance with a first embodiment of the invention will now be discussed, with particular reference being made to FIGS. 10-12. In accordance with the first embodiment, a number of images 103 are made available to any pair of shutter glasses 104 that are within range of the synch signal 106, with data necessary to select images and to view only the selected images being transmitted to each selection device 112 by the data signal 114 from the image source 102. The transceiver 166 additionally transmits a shutter initialization signal 172, causing the shutter glasses 104 to begin operating in a pattern causing only the selected image 103 to be viewed.

FIG. 10 is a graphical view of six time slots 180 as they are arranged, for viewing three-dimensional images 182 and two-dimensional images 184 in accordance with the first embodiment. Each of the three-dimensional images 182 includes an image 186 for the left eye and an image 188 for the right eye, so that the six time slots 180 are needed for two three-dimensional images together with two two-dimensional images, as shown. Alternately, the six time slots 180 can be used for three three-dimensional images only or for six two-dimensional images only.

The same six frames are used for both two- and three-dimensional images, with one frame being needed for each two-dimensional image, and with two frames being needed for each three-dimensional image so that the left and right eyes can be arranged to view different images. The same synch signal 106 is used with both two- and three-dimensional images. Thus, the same pair of shutter glasses 104, and the same selection device 112 can be used both for viewing three-dimensional images from the images source 102 and later for viewing two-dimensional images from one of the other image sources 108. Furthermore, a single image source 102, 108 can provide both two- and three-dimensional images, using a total of six frames, for example with each viewer choosing among two three-dimensional images and two other two-dimensional images. After the sequence of six time slots 130 is completed, the same sequence is repeated, with the following images remaining the same to present stationary images or being changed to present moving images. The six time slots 180 are defined by the synch signal 106, with a primary pulse 192, indicating the first time slot 194, being different from the following secondary pulses 196 in a detectable manner, such as amplitude, duration, or frequency of modulation

Within the shutter glasses 104, shutter control signals 200, including a signal 202 opening the left shutter and a signal 204 opening the right shutter cause these shutters to open and closed separately, so that the two eyes experience different images, with Movie 1 being seen in both eyes as the shutters and opened and closed according to the example of the figure Preferably, these shutter control signals 200 are generated within the shutter glasses 104 from information received from the selection device in a shutter initialization signal 146, with this information being used to determine when the shutter mechanisms within the shutter glasses 104 are to be opened and closed.

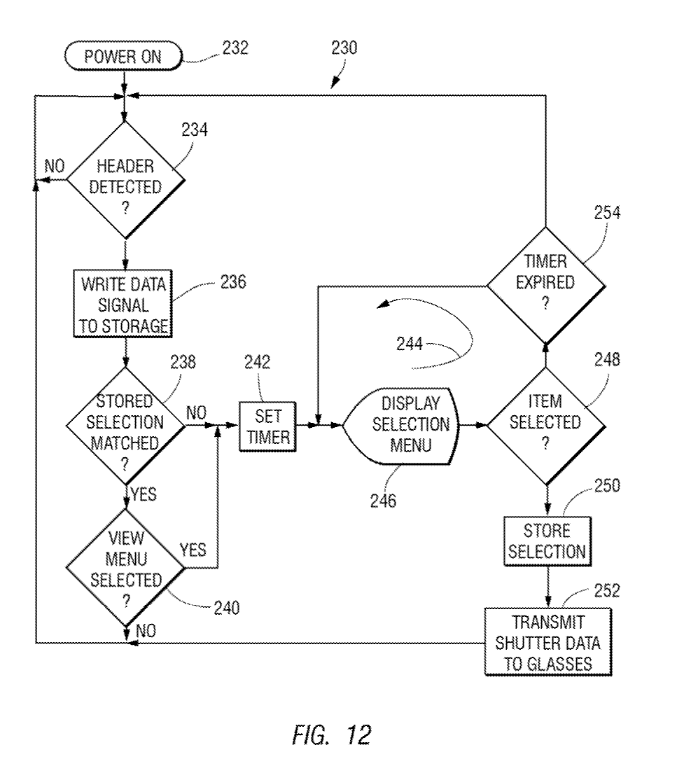

FIG. 11 is a tabular view of a data structure 210 stored within the register 152 of the image source 102 in accordance with the first embodiment of the invention. The data structure 210 comprises a plurality of data records 212, each of which is associated with a particular two- or three-dimensional image being presented by the image source 102. Each of the data records 212 includes a number field 214, a title field 216, a left shutter timing field 218, and a right shutter timing field 220. The number field 214 stores a number that may be used to select the image associated with the data record 212, using, for example, the keyboard 122 of the selection device 113. The title field 216 stores a title, which is preferably easily recognized by individuals wishing to view the images, of the image associated with the data record 212. The left shutter timing field 218 identifies the time slot 180 during which the left shutter is to be opened, and the right shutter timing field 220 identifies the time slot 180 during which the right shutter is to be opened. For two-dimensional images, the left and right shutters are opened at the same time.

In accordance with the first embodiment of the invention, the image source 102 continues to display the same images, with each of the shutter glasses 104 associated with each selection device 112 that is within range of the data signal 114 from the image source 102 being able to receive each of the images described in the data signal 114. The only signal originating from the selection device 112 is the shutter initialization signal 172. In order to minimize jamming or interference between radio signals from different sources in the presence of a large number of selection devices 112 in a limited area, the shutter initialization signal 172 is generated only when the timing of shutter operation is being changed. For example, since it is understood that, when an individual moves from one image source 102 to another, he is likely to continue using the sane menu selection, based his preferences for images to view. Therefore, when his previous selection is determined to still be available, the shutter initialization signal is only generated if he makes a different selection.

FIG. 12 is a flow chart showing a process 230 taking place within the selection device 112 in accordance with the first embodiment of the invention, through the execution of instructions from an app 164 within the microprocessor 160 of the selection device 112. The process 230 can begin at any time with power being turned on in step 232. As previously described, the image source 102 transmits data as the data signal 114 on a periodic basis, beginning with a header and including the information stored in the data record 212 for each available two- or three-dimensional image. Thus, after it is determined in step 234 that the header has been received, data from the data signal 114 is written in step 236 to storage within the selection device 112. Next, in step 238, it is determined whether a previously-made selection of an image is stored and whether it matches a selection that is still available according to the data stored in step 236. If it is, and if a further determination is made in step 240 that the “view menu” button 134 is not being depressed, the selection that has been previously made and stored will be retained, so the process 230 returns to step 234 to wait to receive another header.

On the other hand, if it is determined in step 238 that the stored selection does not match a menu item listed within the data signal information stored in step 236, or if it is determined in step 240 that the “view menu” button 134 is being depressed, a timer is set in step 242 before the process 230 enters a loop 244 to display the selection menu within the display 168. Within the loop 244, the display is turned on in step 246. If it is then determined in step 248 that one of the menu items 116, 128 has been selected, the selection is stored in step 250. Then, in step 252, the shutter timing data, which has been stored in step 236, for the image associated with the selection is transmitted to the shutter glasses as the shutter initialization signal 172, so that both the left and right shutters therein will open only to reveal the selected two- or three-dimensional image. After transmitting the shutter timing data in step 258, the process 230 returns to step 234. If it is determined in step 254 that timer set in step 242 has expired, the process 230 also returns to step 234/In either case, the display 168 is turned off when the process 230 leaves the loop 244 to conserve battery power within the selection device 112.

It is anticipated that many applications of the present invention will involve the use of a relatively large number of shutter glasses 104 within an area, such as an auditorium, receiving images 103 and a data signal 114 from a single image source 102. A particular advantage of the first embodiment of the invention is realized in such a situation, since the transmission of data from individual selection devices 112, with resulting problems caused by the collision of data transmissions, is minimized. The selection devices 112 only communicate with their associated shutter glasses 104, and only when it has been determined that it is necessary to change the shutter timing conditions within the shutter glasses 104.

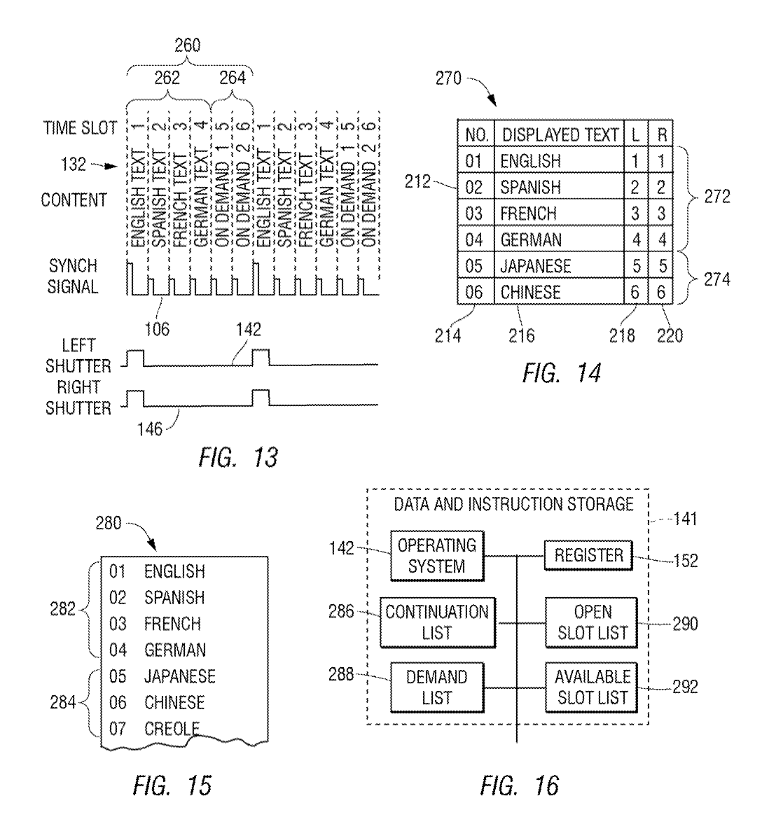

Operation of the system 100 for viewing multiplexed images in accordance with a second embodiment of the invention will now be discussed, with particular reference being made to FIGS. 13-18. In the second embodiment of the invention, the image source 102 is provided with an ability to display more different kinds images than the number of images that can be displayed at the same time. For example, the number of images that can be displayed at the same time may be limited to six two-dimensional images or three three-dimensional images due to limitations of the shutter glasses 104. In accordance with the second embodiment, menu items associated with more different images than the number that can be displayed at once are provided, with one or more of the time slots available for displaying images being reserved for the display of “on demand” images chosen by the individuals using the shutter glasses 102.

FIG. 13 is a graphical view showing the allocation of time slots 260 for viewing multiple images from the image source 102 in accordance with the second embodiment of the invention. In the example of the figure, six time slots 260 are used for the sequential display of six images 103 at a rate sufficient to make each of the images appear to the viewer to be displayed continuously. For example, signs including text in various languages are displayed, with sign images having English, Spanish, French, and German text being presented, respectively, in the first four time slots 262, and with the sixth and seventh time slots 264 being used to display other languages selected by viewers, such as the Japanese and Chinese languages shown. To control operation of the shutter glasses 104, the time slots 260 are defined by the synch signal 106 from the image source 102 as previously described in reference to FIG. 10. Within the shutter glasses 104, the left shutter signal 142 and the right shutter signal 146 open the shutters simultaneously for two-dimensional images, with these signals being shown as they are switched to view images with English text.

The second embodiment of the invention provides particular advantages in such an application, where it can be determined that most viewers will use several images, such as signs having text in languages most commonly used in an area, but that other viewers will use other images, such as signs having text in languages less frequently used in the area. While the second embodiment is explained as a single image screen having six time slots 262 presenting two-dimensional images, this example is not meant to be limiting. For example, the second embodiment of the invention may be implemented using an image source 102 having a number of display screens, one or more of which is devoted to providing only on-demand time slots, and certain time slots in one or more of the displays may be configured for displaying three-dimensional images.

FIG. 14 is a tabular view of a data structure 270 stored within the register 152 of the image source 102 in accordance with the second embodiment of the invention. The data structure 270 includes data records 212 and fields 214, 216, 218, and 220 as described above in reference to FIG. 11. In the example of the figure, the first four data records 272 always are associated with the same images, while the last two data records 274 are associated with on-demand images that have been requested by viewers. Data in the last two data-records form an on-demand slot list 274 that is changed according to new requests for different images to reflect the on-demand images currently being displayed.

FIG. 15 is a display screen view of a menu 280 displayed in the display 268 of the selection device 212 in accordance with the second embodiment of the invention. Images corresponding to the first four entries 282 can be reached at all times, while images corresponding to the remaining entries 284 can be displayed depending on the availability of on-demand time slots 268.

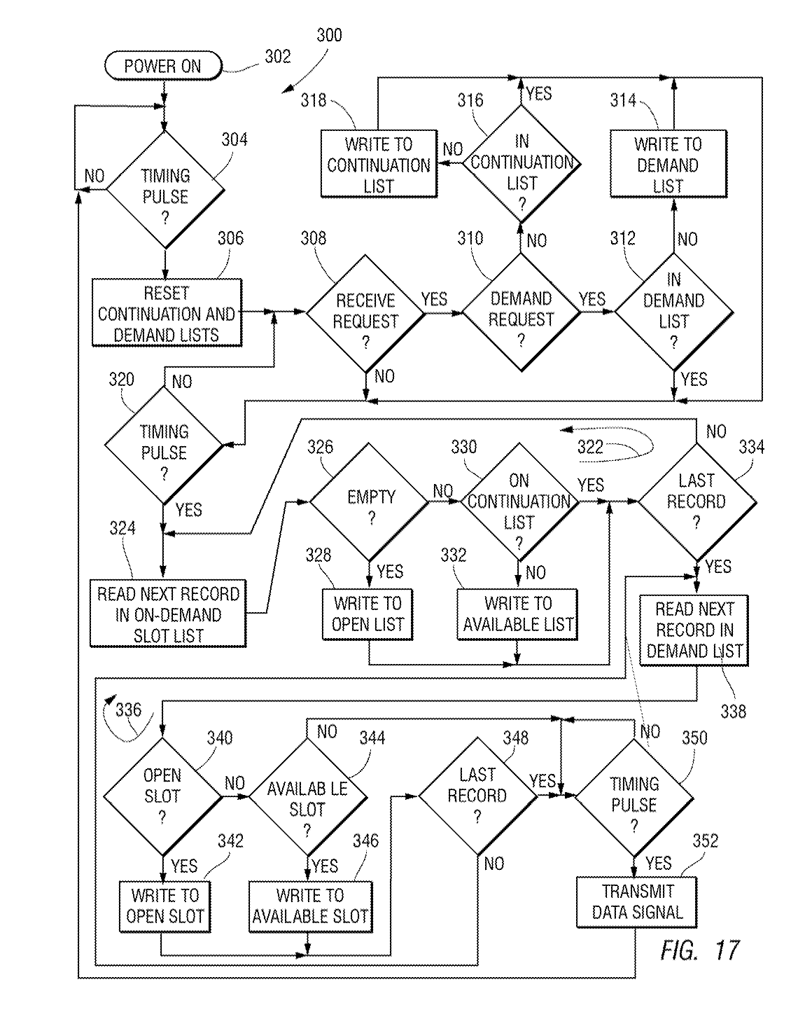

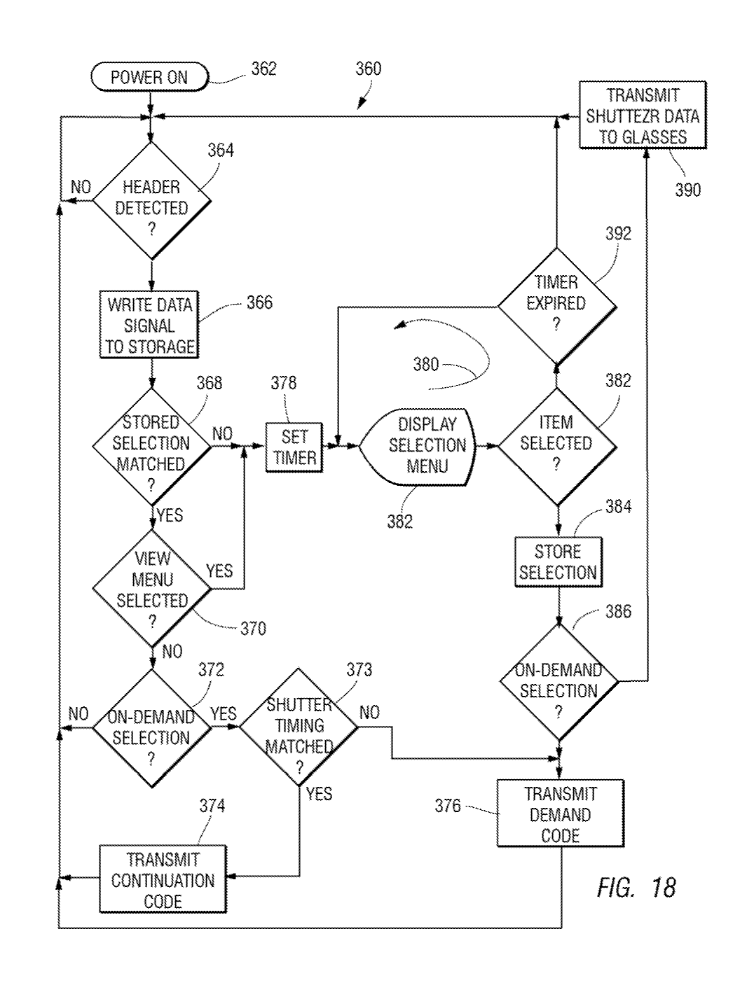

FIG. 16 is a schematic view of data and instruction storage 141 within the image source 102, configured for operation in accordance with the second embodiment of the invention to include a continuation list 286 holding data identifying slots within the on-demand slot list 274 of the data structure 270 describing images, for which requests for continued displaying are being received, and a demand list 288 holding data identifying on-demand images that are not being displayed, for which requests for display are being received. Data and instruction storage 141 additionally includes a available slot list 292, which includes data describing the on-demand slots that are considered available because they are either open or because they are used to display images for which continuation requests are not being received.

FIG. 17 is a flow chart showing a process 300 occurring within the image source 102 under control of program instructions executing within the microprocessor 144 therein, in order to control the presentation of images within the on-demand time slots in response to requests to view particular images. The on-demand images that are presented and viewed are determined by writing to the data records within the on-demand slot list 274, since these data records determine which images are projected, and. through the data signal 114, the timing of shutters within the shutter glasses 104 to receive the images.

The execution of steps within the process 300 is established by three timing pulses. The process may be started at any time, for example by turning on electrical power in step 302. In accordance with the second embodiment of the invention, data records 274 within the data structure 270 describe on-demand images that are presently being displayed by the image source 102. If one of these on-demand images is no longer being requested, an assumption is made that the individual requesting the image is no longer viewing it, so that the time slot 264 used for the images is considered to be available for the presentation of another image, Therefore, a list of currently presented on-demand images for which continuation requests are being received and a list of on-demand images for which requests are being received are stored within data storage accessed by the microprocessor 144, in the form of the continuation list 286 and the demand list 288, respectively.

Thus, after it is determined in step 304 that the first timing pulse has occurred, the continuation and demand lists are erased in step 306, allowing these lists to be filled only with currently, not previously, presented requests. Then, after it is determined in step 308 that a request us being received, a further determination is made in step 310 of whether a demand for a new on-demand image has been received. If it has, and if it is then determined in step 312 that a demand request for the particular on-demand image being requested is not already stored within the demand list, the demand request is written to the demand list in step 314. On the other hand, if it is determined in step 310 that the request received in step 308 is not a demand request, it is assumed that it is a request to continue presenting an on-demand image currently being displayed. Therefore, after it is determined in step 316 that a continuation request for the particular on-demand image is not already stored in the continuation list, this new continuation request is written to the continuation list in step 318. This process is repeated, with the demand and continuation lists being filled according to requests currently received from the selection devices 112 until it is determined in step 320 that the second timing pulse has been received.

After it is determined in step 320 that the second timing pulse has been received, the process 300 enters a loop 322, in which individual records within the on-demand slot list 274 within the data structure 270 are examined in an attempt to fill as many time slots as possible with new images being requested while continuing to display the currently displayed images for which continuation requests are being received. Thus, each time the loop 322 is traversed, the next data record 212 in the on-demand slot list 274 is read in step 324, starting with the first data record. If it is determined in step 326 that the data record 212 indicates the slot is open, causing no image to be displayed, data describing the slot is written to the open slot list 290 in step 328. If it is determined in step 326 that the slot is not open, and then in step 330 that the slot is not on the continuation list 286, data describing the slot is written to the available slot list 292 in step 332. After data describing the slot is written in steps 328 and 332, of if it is determined in step 330 that the slot is described in the continuation list 286 and then in step 334 that the slot is not the last slot in the on-demand slot list 274, data for the next slot is read in step 324.

If it is determined in step 334 that the slot being examined is the last slot in the on-demand slot list 274, the process 300 enters a loop 336, in which data is written to the register 152 to change the on-demand images that will be displayed. Each time the loop 336 is traversed, the next record within the demand list 288 is read in step 338, starting with the first such record, with an attempt then being made to place data describing the image associated with the record in either an open slot or an available slot, for which no continuation request is being received. Thus, when it is determined in step 340 that there is an open slot, data describing the record currently being examined from the demand list 288 is written in step 342 to the on-demand slot list 274 within the register 152. When it is determined in step 340 that there is no open slot within the on-demand slot list 274, and when a further determination is then made in step 344 that there is an available slot in the available slot list 292, data describing the record currently being examined from the demand list 288 is written to the first available slot within the on-demand slot list 274 in step 346.

After data is written to the on-demand slot list 274 in step 342 or in step 246, a further determination is made in step 348 of whether the record being examined in the last record within the demand list 238. If it is not, it is determined that the processes of loop 336 have been completed, with all of the images for which demand requests are being made being placed within open or available slots, so the process 300 goes to step 348 to wait for the next timing pulse. Furthermore, when it is determined in step 344 that, since there are no more empty slots and no more available slots, it is known that the processes of loop 336 have been completed, since no more images can be placed, so the process 300 goes to step 350 to wait for the next timing pulse. In either case, when it is determined in step 350 that the next timing pulse has occurred, in step 350, the images being transmitted are updated to reflect the changes that have been made to the on-demand slot list 174, and the data signal 114 is transmitted in step 352 to the control devices 126 with these changes.

FIG. 18 is a flow chart showing a process 360 occurring within the selection device 119 in accordance with the second embodiment of the invention. In accordance with the second embodiment of the invention, the selection of an image that is not an on-demand image results in the generation of a shutter initialization signal 172, so that one of the available images can be viewed. On the other hand, when an on-demand image is selected a continuation request is generated if the images is currently being displayed, and a demand request is generated if the image is not currently being displayed. The process 360 can begin at any time with power being turned on in step 362. As previously described, the image source 102 transmits data as the data signal 114 on a periodic basis, beginning with a header and including the information stored in the data record 212 for each available two- or three-dimensional image. Thus, after it is determined in step 364 that the header has been received, data from the data signal 114 is written in step 366 to storage within the selection device 112. Next, in step 368, it is determined whether a previously-made selection of an image is stored and whether it matches a selection that is still available according to the data stored in step 366. If it is, if a determination is additionally made in step 370 that the “view menu” button 134 is not being depressed, and if yet another determination in step 372 indicates that the stored selection found in step 368 is not for an on-demand image, it is known that the selection that has been previously made and stored will be retained, so the process 230 returns to step 234 to wait to receive another header. If it is determined in step 372 that the selection is for an on-demand image, a further determination is made in step 373 of whether the selected image is still available at the present shutter settings, as it would be if the selection device 104 has not been moved away from the image source 102. If it is still available, a continuation request is generated in step 374; if it has not, a demand request is generated in step 376 before returning to step 364.

If it is determined in step 368 that the stored selection does not match a menu item listed within the data signal information stored in step 236, or if it is determined in step 370 that the “view menu” button 134 is being depressed, a timer is set in step 378 before the process 300 enters a loop 380 to display the selection menu within the display 168. Within the loop 380, the display is turned on in step 382. If it is then determined in step 384 that one of the menu items 116, 128 has been selected, the selection is stored in step 386. Then, if it is additionally determined in step 388 that the selection is not an on-demand selection, the shutter timing data, which has been stored in step 236, for the image associated with the selection is transmitted to the shutter glasses as the shutter initialization signal 172, in step 390, so that both the left and right shutters therein will open only to reveal the selected two- or three-dimensional image. After transmitting the shutter timing data, the process 230 returns to step 364 to wait for the next header. If it is instead determined in step 388 that an in-demand image has been selected, a demand request for the image is sent in step 376. If it is determined in step 392 that timer set in step 242 has expired, the process 230 also returns to step 234. The display 168 is turned off when the process 230 leaves the loop 244 to conserve battery power within the selection device 112.

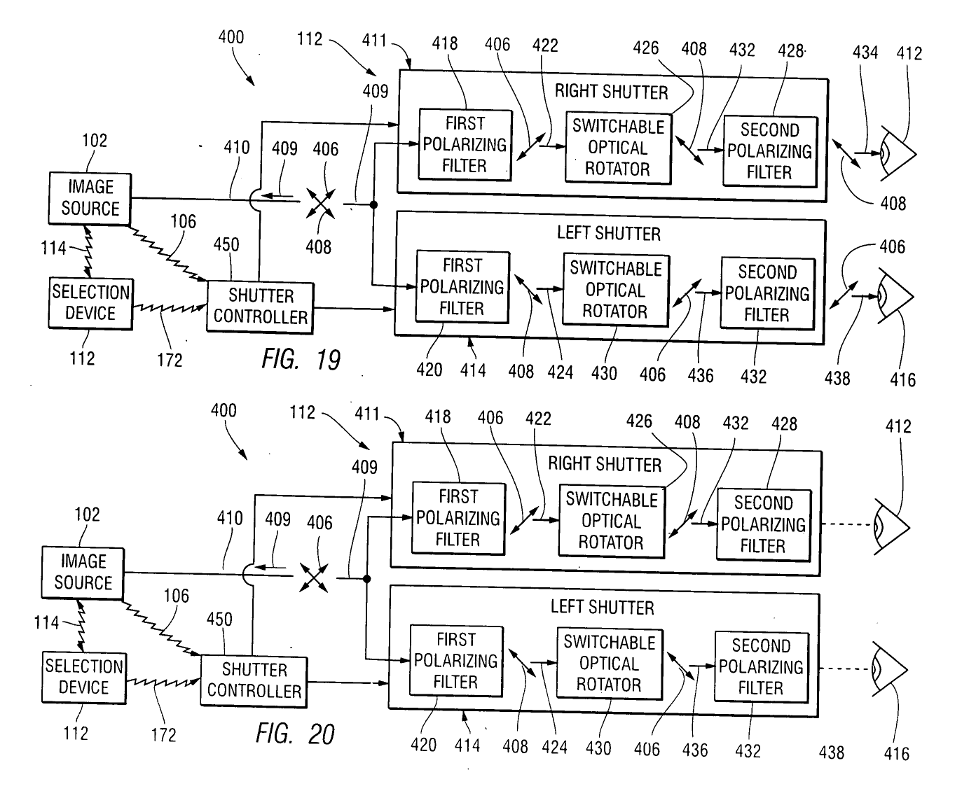

A third embodiment of the invention will now be discussed, with particular reference being made to FIGS. 19-22. In accordance with the third embodiment of the invention, the image source 102 produces a pair of images that are polarized at angles orthogonal to one another, and the shutter glasses include a left shutter that passes only one of the images and a right shutter that passes only the other of the images. Preferably, the images are additionally time-multiplexed so that multiple images can be presented.

FIGS. 19 and 20 are schematic views of a system 400 for viewing multiplexed images, configured in accordance with a third embodiment of the invention, with the image source 102 being configured to form a right image polarized in a first direction, as indicated by arrow 406 and a left image, polarized in a second direction, indicated by arrow 408 orthogonal to the first direction. It is noted that the arrows 406, 408 are drawn as they would be seen looking in the direction of arrow 409 along the light pattern 410. The light pattern 409 forming the right and left images is transferred to the shutter glasses 112, which include a right shutter 411 directed toward the right eye 412 and a left shutter 414 directed to the left eye 416. The right shutter 411 includes a right first polarizing filter 418, which passes light polarized in the first direction of arrow 406 while blocking light polarized in the second direction of arrow 408. The left shutter 414 includes a left first polarizing filter 420 which passes light polarized in the second direction of arrow 408 while blocking light polarized in the first direction of arrow 406. Thus, the right first polarizing filter 418 of the right shutter 411 passes only the right image to the right eye 412, in the form of a right first intermediate light pattern 422, while the left first polarizing filter 420 of the left shutter 414 passes only the left image to the left eye 416, in the form of a left first intermediate light pattern 424.

Each of the shutters 411, 414 includes a synchronous optical rotator 426, 430, which is electrically switched to move operate within a “closed’ position, in which polarized light moves through the rotator 426, 430 without rotation, and an “open” position, in which polarized light is rotated through a 90-degree angle as it passes through the rotator 426, 430. Each of the shutters 411, 441 additionally includes a second polarizing filter 428, 432 that is arranged to block light when the optical rotator rotates the light to form an intermediate light pattern 432, 436, as shown in FIG. 18, and to block an intermediate light pattern 432, 436 that is not rotated by the rotator 426, 430, as shown in FIG. 20. Thus, the shutters pass polarized output light pattern 434, 438 when the shutters are opened and pass no light while the shutters are closed.

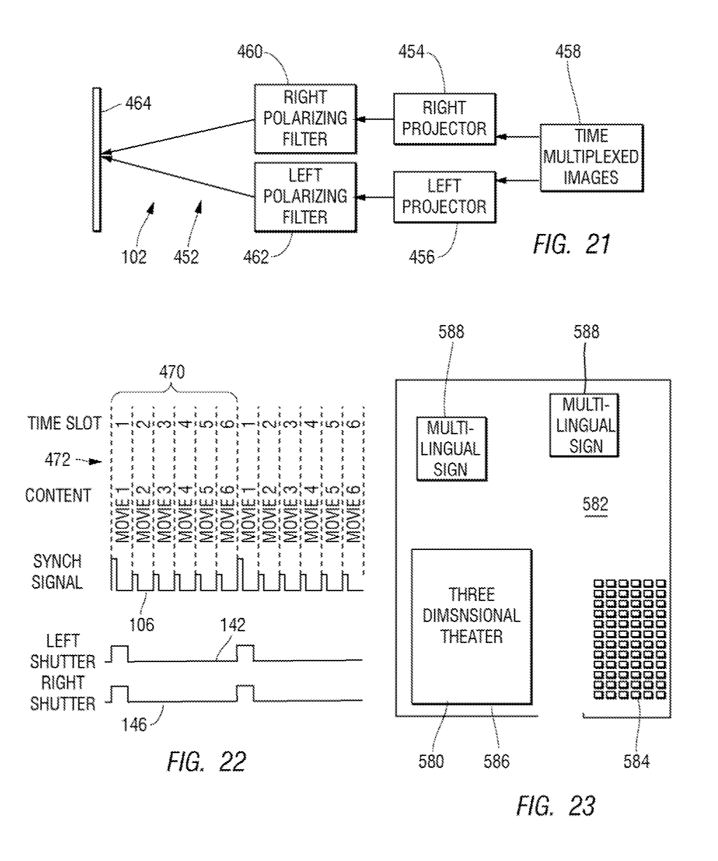

FIG. 21 is a schematic view of a version 452 of the image source 102 that is configured to orthogonally polarized right and left images in accordance with the third embodiment. The version 452 includes a right projector 454, which projects a series of composite images 456 intended for the right eye 412, while the left projector 458 projects a series of multiplexed images 456 intended for the left eye, with both sets of images being aimed through a polarizing filter 450, 452 at a screen 464. The art of projecting polarized images to form three-dimensional without multiplexing is well known, and it is further known that such images may be seen through front-screen or rear-screen projection. Therefore, the right polarizing filter 460 is arranged so that the image from the right projector 454 reaches the shutter glasses 460 as polarized in the first angle of arrow 406, while the left polarizing filter 452 is arranged so that the image from the left projector 458 reaches the shutter glasses 460 as polarized in the second angle of arrow 408.

FIG. 22 is a schematic view of an allocation of time slots for viewing multiple three-dimensional images in accordance with the third embodiment of the invention. Since a division has been formed between the images for the right eye 412 and the left eye 416 as a result of the cross-polarization of the images three-dimensional images can be presented simultaneously in the same time allowed for six two-dimensional images in other embodiments. This provides the third embodiment with a significant advantage, allowing the left and right shutters to be operated at the same time, requiring only one time slot instead of two for three-dimensional images, as required for other embodiments, and therefore providing for more images to be shown. For example, FIG. 23 shows six three-dimension images 470, such as movies, being shown in six individual time slots 472, with the left and right shutters being opened and closed together. While it may be possible to show twelve two-dimensional images in this way, it is considered to be more desirable to show such images simultaneously to both eyes.

FIG. 23 is a schematic view of a first system for viewing multiplexed images in accordance with a fourth embodiment of the invention, with elements of the system being arranged in an enclosure 580, such as a fence or wall around a theme park 582, and in a number of kits 584. After entering the enclosure 582, some or all of the visitors are loaned a kit 584 for their own use within the enclosure 580 to view two- or three-dimensional images within a theater 586 Visitors can also use the kits to view multi-lingual signs 588 in their own language within the enclosure 580 before returning the kits when the leave the enclosure 580.

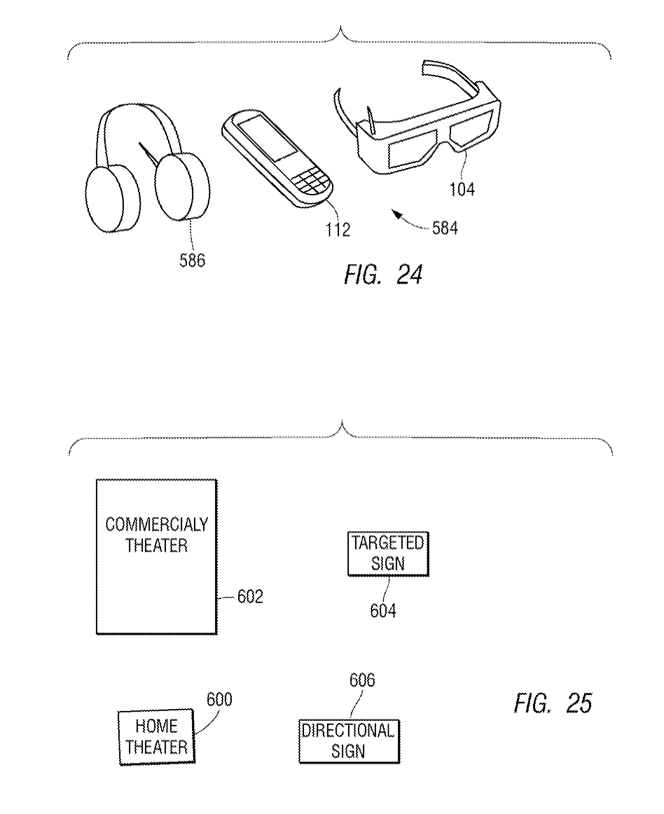

FIG. 24 is a perspective view of the contents of a kit 584 within the enclosure 580. The kit 584 includes shutter glasses 104, a selection device 112, and earphones 586. While these components are preferably battery powered and connected by batteries, they are alliteratively connected by cables. While the assembly and presentation of audio material along with the images discussed above as parts of the first, second, and third embodiments is not discussed above, this has been done merely to clarify the differences among the first three embodiments, each of which can readily be used with corresponding audio tracks. For example, the selection device 121 is used to select images as described above, while simultaneously selecting an audio program corresponding to the images from a number of audio programs broadcast on different radia channels from the image source 102.

FIG. 25 is a partial schematic view of a second system for viewing multiplexed images in accordance with a fourth embodiment of the invention. The system comprises a number of elements that are remote from one another, including a home theater 600, a commercial theater 602, a targeted sign 604, and a directional sign 606. The same selection device 212 is used to select images within all of these elements, becoming operational with each element as it is brought into range of the element In the home theater 600 and in the commercial theater 602, a number of people with differing interests can watch their favorite types of movies in two- or three-dimensions. At the targeted sign 604, an individual can see content developed for his reference group, such as men, women, boys, girls, or young people. At the directional sign 606, an individual can easily find his destination by selecting it using the selection device 102.

When various image sources are placed at locations remote from one another, as shown in FIGS. 24 and 25, contact with radio signals from the image sources will be lost and reestablished as an individual moves from one location to another. Preferably, the program executing within the selection device 112 will then establish whether the images previously being viewed are available from the new image source. If they are, they will continue being viewed at the new location, otherwise a menu screen will be presented for a new selection.

While the invention has been described in terms of preferred embodiments with some degree of particularity, it is understood that this description has been given only by way of example, and that many changes, including various combinations of the embodiments, can be made without departing from the spirit and scope of the invention, as defined in the appended claims.

What is claimed is:

1. Apparatus displaying and viewing multiple images on a single screen, wherein the viewing apparatus comprises:
an image source displaying multiple images on a single screen, separated by time multiplexing, and broadcasting a synch signal, indicating when the images are changed for one another and a data signal describing content of the multiple images and a pattern in which the individual images are displayed;
a plurality of hand-held selection devices, each receiving the data signal from the image source and displaying a menu screen showing available image selections, each accepting a user selection of an available image, and each associated with one of the shutter glasses to transmit a shutter initialization signal to the shutter glasses, causing the shutter glasses to then open as needed to view the selected image; and
a plurality of shutter glasses, each arranged to fit over a nose and ears of a wearer while holding a right shutter therein in line with the right eye of the user and a left shutter therein in line with the left eye of the user, and wherein each of the shutter glasses begins to transmit the selected image after receiving the shutter initialization signal from the selection device associated with the shutter glasses to continue transmitting only the selected image as long as it is available unless required to do otherwise by a user action.

2. The apparatus of claim 1, wherein the image source displays a first plurality of two-dimensional images, time-multiplexed to be each held within a single time slot.

3. The apparatus of claim 1, wherein the image source displays a second plurality of three-dimensional images, each including a right image intended for the right eye and a left image, intended for the left eye, wherein the left and right images are in different slots as time multiplexed, and wherein the images together are arranged to provide a viewer wit6h a sense of a three-dimensional image.

4. The apparatus of claim 1, wherein the image source displays a first plurality of two-dimensional images, each time-multiplexed to be each held within a single time slot, and
a second plurality of three-dimensional images, each including a right image intended for the right eye and a left image, intended for the left eye, wherein the left and right images are in different slots as time multiplexed.

5. The apparatus of claim 1, wherein
the image source additionally broadcasts a plurality of sound tracks, each associated with one or more images in the first plurality of images,
the apparatus additionally includes at least one earphone associated with each selection device, and
the hand-held selection devices causes the at least one earphone to be tuned to a radio channel from the image source through which audio associated with the selected images is being played.

6. The apparatus of claim 1, wherein the selection device comprises a cell phone executing an app for controlling the viewing of images in communication with the shutter glasses and with the image source.

7. The apparatus of claim 1, wherein the image source provides a first plurality of images that are all being displayed for immediate selection and at least one on-demand slot among the time slots formed by time-multiplexing to be filled by an image selected using one of the selection devices from a second plurality of images not being displayed.

8. The apparatus of claim 7, wherein, while as one of the control devices receives an indication that a user wants to continue viewing an image from an on-demand slot a program executing within the causes a continuation request to be transmitted from the control device, so that the image supplier will retain the image in the on-demand slot, in response to a determination that the image is still available, and instead causes the selection device to generate a demand request to place the image in an on-demand slot in response to a determination that the image is no longer available.

9. The apparatus of claim 1, wherein
the image source displays a plurality of three-dimensional images, each including a right image intended for the right eye and a left image, intended for the left eye,
the images together are arranged to provide a viewer with a sense of a three-dimensional image.
the image source polarizes the right image in a first direction and polarizes the left image in a second direction, orthogonal to the first direction,
the right shutter is additionally arranged to transmit only light polarized in the first direction to the right eye of the viewer, and
the left shutter is additionally arranged to transmit only light polarized in the second direction to the left eye of the viewer.

10. The apparatus of claim 9, wherein
the right shutter of the shutter glasses comprises a first right polarizing filter passing light polarized in the first direction and blocking light polarized in the second direction, a right switchable rotator that rotates a direction of polarization of light from the first right polarizing filter through a 90-degree angle with the rights switchable rotator switched on and passing light from the first right polarizing filter without rotation with the right switchable rotator switched off, and a second right polarizing filter blocking light from the right switchable rotator polarized in the first direction and passing light from the right switchable rotator polarized in the second direction, and
the left shutter of the shutter glasses comprises a left right polarizing filter passing light polarized in the second direction and blocking light polarized in the first direction, a left switchable rotator that rotates a direction of polarization of light from the first left polarizing filter through a 90-degree angle with the left switchable rotator switched on and passing light from the first left polarizing filter without rotation with the right switchable rotator switched off, and a second left polarizing filter blocking light from the right switchable rotator polarized in the second direction and passing light from the right switchable rotator polarized in the first direction.

11. The apparatus of claim 9, wherein the left and right images forming a single three-dimensional image are in a single time slot as multiplexed.

12. The apparatus of claim 1, wherein at least some of the images are displayed over time as part of a series of images forming a moving picture.

13. The apparatus of claim 1, comprising a plurality of image sources, wherein
each image source displays multiple images on a single screen, separated by time multiplexing, and broadcasting a synch signal, indicating when the images are changed for one another and a data signal describing content of the multiple images and a pattern in which the individual images are displayed;
each of the selection devices receiving a data signal displays a menu derived from information received within the data signal accepts a user selection of an item from the men, and transmits a shutter initialization signal, starting the shutter glasses associated with the selection device operating to transmit the images associated with the menu item.

14. The apparatus of claim 13, wherein, after losing contact with the data signal, upon regaining contact with the data signal the selection device establishes that the data signal indicates that a previously selected image is still available and transmits a shutter initialization signal causing the shutter glasses to transmit the previously selected image.

15. The apparatus of claim 14, wherein one of the image sources provides a first plurality of images that are all being displayed for immediate selection and wherein another of the image sources provides at least one on-demand slot among the time slots formed by time-multiplexing to be filled by an image selected using one of the selection devices from a second plurality of images not being displayed.

16. The apparatus of claim 15, wherein, as one of the control devices receives an indication that a user wants to continue viewing an image from an on-demand slot a program executing within the causes a continuation request to be transmitted from the control device, so that the image supplier will retain the image in the on-demand slot, in response to a determination that the image is still available, and instead causes the selection device to generate a demand request to place the image in an on-demand slot in response to a determination that the image is no longer available.

17. The apparatus of claim 16, wherein
the second plurality of the images includes signs in languages that are not commonly used locally,
images within the first plurality are held in locations within the time-multiplexing structure form which they can always be selected for display using any of the selection devices, and
images within the second plurality are held in the on-demand slots within the time multiplexing.

18. The apparatus of claim 13, wherein
one of the image sources comprises a theater displaying a plurality of three-dimensional movies including sound, and
another of the image sources comprises a sign.

19. The apparatus of claim 18, wherein
the sign includes a plurality of images of directions for reaching different destinations, and
the images within the sign are each selected according to a direction.

20. The apparatus of claim 18, wherein
the sign includes a plurality of messages targeted for different demographic groups, and
the images within the sign are each selected according to a demographic group.
